(19) United States
(12) Patent Application Publication
(10) Pub. No.: US 2008/0206388 A1
(43) Pub. Date: Aug. 28, 2008

(54) Doughnut making machine

(76) Inventors: Gregg A. Bond, Oxnard, CA (US); Kenneth A. Tarlow, Corte Madera, CA (US)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 11/711,216

(22) Filed: Feb. 27, 2007

(51) Int. Cl. A21C 11/16

(52) U.S. Cl. 425/288

(57) ABSTRACT

Doughnut making machine with a metal trough, a heating element, a doughnut pushing chain assembly, a chain drive motor, a doughnut batter hopper, a motorized batter dispensing mechanism, a plurality of chain idler pulleys, a chain drive motor and attached pulley, and doughnut flipping fingers. The is chain is wrapped into a belt and is driven by the chain drive pulley that is in turn driven by the chain drive motor. The chain is wrapped around the idler pulleys in a secure fashion. The dispensing mechanism activates when the belt switch activators contact a dough dispensing switch located on the chain. The batter is dropped into the oil that resides in the trough. The heated oil causes the doughnut mixture to fry. The resulting doughnut shape is propelled forward by chain push fingers. The flipping fingers offer resistance to the doughnut causing it to flip over.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of household electric cooking devices and more specifically to a doughnut making machine.

Doughnuts are a popular treat in many parts of the world. They are typically round and have a hole in the center. They are made of dough and are fried in oil and often covered with a variety of sweet toppings.

Doughnut making machines are well known and are designed to make doughnuts quickly and in a repeatable manner.

However, most doughnut making machines are designed for commercial use and not for home use. They tend to cost many thousands of dollars, making it prohibitive for an individual or family to purchase one for home use. Therefore most people buy doughnuts at a retail outlet rather than making them at home.

### BRIEF SUMMARY OF THE INVENTION

The primary object of the invention is to provide a doughnut making machine that can be used in a home environment.

Another object of the invention is to provide a doughnut making machine that is economical to manufacture.

Another object of the invention is to provide a doughnut making machine that automatically flips doughnuts.

A further object of the invention is to provide a doughnut making machine that can be converted to a potato chip making machine.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a doughnut making machine comprising: an outer housing enclosing a metal trough, a heating element, a conveying chain including an attached plurality of evenly spaced doughnut pushing fingers on one side and a plurality of switch activating tabs on the opposite side, a chain drive motor, a chain drive pulley, a removable doughnut mixture hopper including a motorized mixture dispensing mechanism, a temperature sensing switch, a plurality of chain guide pulleys, doughnut flipping fingers, a removable rear panel, a removable transparent housing cover, a power switch, a power cord, a dough dispensing switch, a chain drive power switch, a heater switch, said chain being driven by said chain drive pulley that is in turn driven by said chain drive motor, said chain being wrapped around said idler pulleys, said mixture dispensing mechanism located in a receiving aperture on the top surface of said housing enclosure, said dispensing mechanism activates when said chain switch activator senses the presence of said chain tabs, said doughnut mixture being dropped into said metal trough, said trough having a heating element in intimate contact with its bottom most surface so that oil that resides in said trough can be heated causing said doughnut mixture to fry, said resulting doughnut shape propelled forward by said push fingers, said flipping fingers located mid way along said trough and offering resistance to said doughnut causing it to flip over, said trough including an angled end wall that causes said doughnut to be slid out of said oil and dropped over the end of said trough into an external tray, said trough and said chain drive assembly covered by a removable and replaceable cover, said dispenser motor and said chain drive motor and said heating element powered by said power cord that is plugged into a 120 VAC outlet and said power switch activating said belt drive motor and said heating element.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a front perspective view of the invention with transparent lid removed.

FIG. 2 is a front section view of the invention.

FIG. 3 is a front view of the invention.

FIG. 4 is a rear perspective view of the invention

FIG. 5 is a section view of a first doughnut position

FIG. 6 is a section view of a second doughnut position.

FIG. 7 is a section view of a third doughnut position.

FIG. 8 is a a section view of a fourth doughnut position.

FIG. 9 is a section view of a potato slicer accessory for the present invention.

FIG. 10 is an exploded view of a potato slicer accessory for the present invention.

FIG. 11 is a top view of the present invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

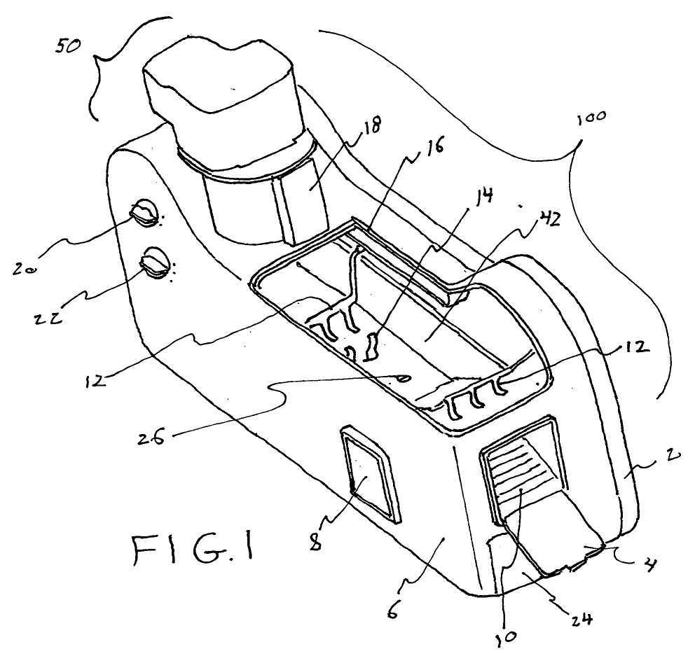

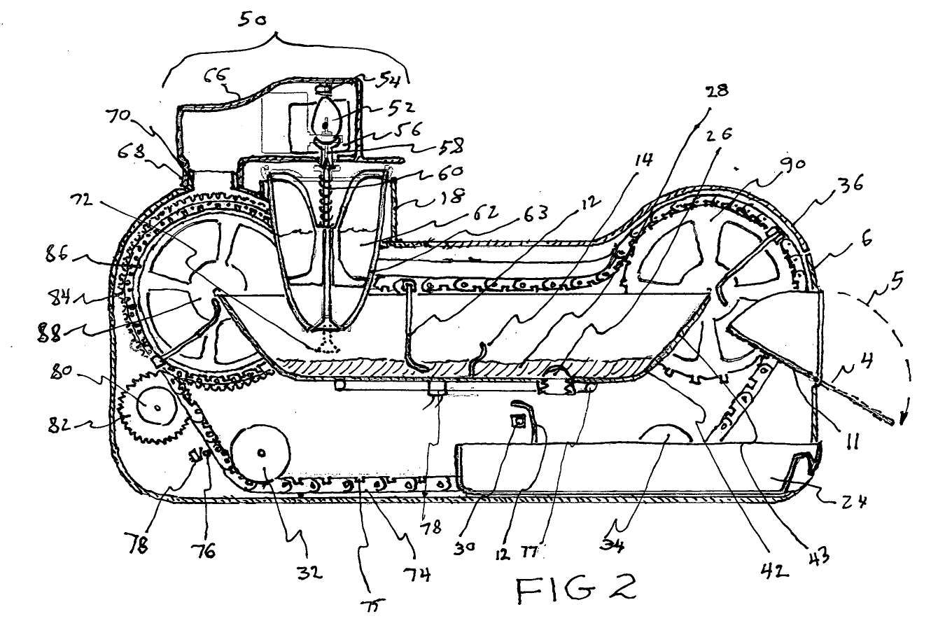

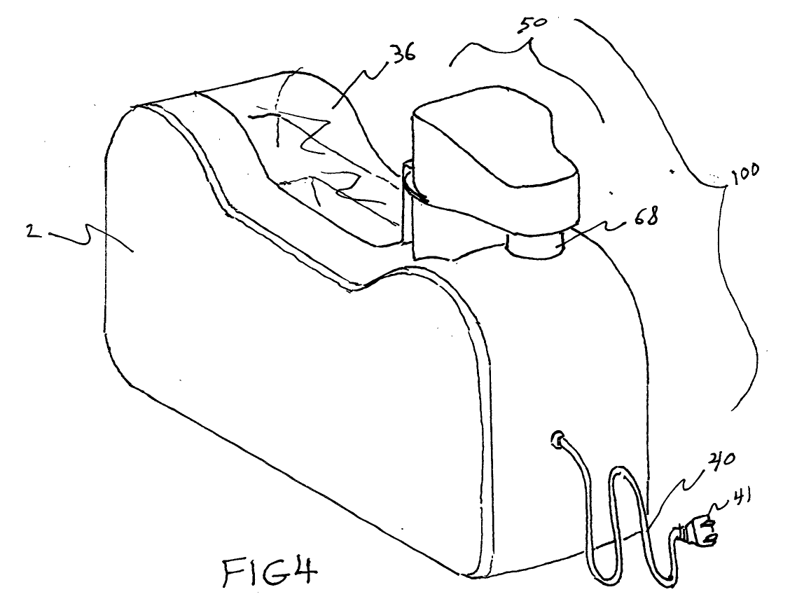

Referring now to FIG. 1 we see a perspective view of the invention 100. The housing consists of a molded front, bottom and side portion 6 and a removable rear panel 2. A transparent viewing panel 36 shown in FIG. 4 has been removed in the FIG. 1 view to show internal components such as trough 42, doughnut pushing arms 12 and doughnut flipping arm 14. Doughnut dispensing assembly 50 is removable and replaceable so that doughnut batter can be poured into a hopper 63 shown in FIG. 2. Metal trough 42 can retain hot cooking oil 28 as shown in FIG. 2. Doughnuts are formed and dropped from doughnut making assembly 50 and float on top of hot cooking oil 28. The doughnut is pushed along by pushing arm 12. When the doughnut is fully cooked, it slides out of chute 4 into a waiting tray or dish of the user's choosing. When the user opens door hatch 8, it releases oil disposal tray 24 so that it can be pulled out from the side of the housing 6. Used oil can be drained from trough 42 by removing threaded closure 26. The used oil drains down to disposal tray 24. The tray 24 is then pulled out and the oil 28 is disposed of. Switch 20 turns on, or off the oil heating element 77. Switch 22 turns on or off the chain drive motor 80.

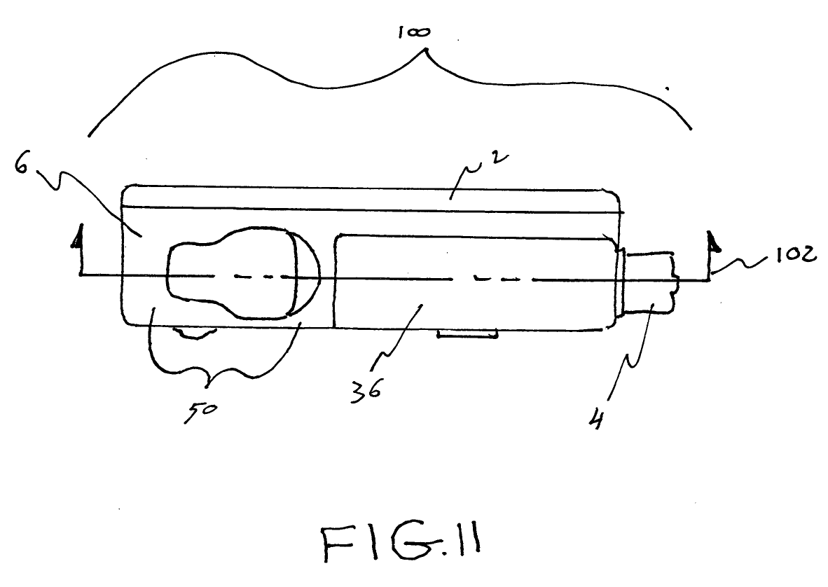

FIG. 2 shows a front section view of the invention as defined by section line 102 shown in the FIG. 11 top view drawing. The components of doughnut making assembly 50 are enclosed in housing 66. Gear motor 56 rotates cam 52 which in turn presses down on dispensing arm top 58. When the cam 52 pushes down on the spring biased 60 arm top 58, it forces the dispensing arm bottom 72 to move down thereby letting a controlled amount of doughnut batter 62 drop into hot oil 28 residing in oil trough 42. The oil is heated by heating element 77. The ideal temperature of three hundred and sixty degrees Fahrenheit is maintained by temperature sensing switch 78. After dispensing, the cam 52 then rotates up so that dispenser arm bottom 72 seals the opening in hopper 63 thereby retaining the remainder of the batter 62 until the next dispensing event. The dispensing events are controlled by micro switches 78 and 54. Tabs 76 located on the outside of chain drive 74 are evenly spaced so that when a tab 76 pushes down on the lever arm of micro switch 78, the doughnut dispensing drive motor 56 is activated, When the drive motor 56 turns the cam 52 one complete revolution, the cam lobe interacts with the lever arm of the normally on micro switch 54 causing the switch to move to the off position thereby turning off drive motor 56 until it is triggered by the next tab 76 on chain 74 as it makes its way around the course defined by chain drive wheel 88 and chain guide wheels 90, 32 and 34. An alternate method of activating dispensing motor 56 is to use a photo diode 30 which watches for the doughnut pushing arms 12 as they pass by causing the drive motor 56 to receive power. This method would require a micro processor and associated electronics mounted on a PC board. The drive chain 74 is made of links. Certain links each include a receiving aperture for accepting push arm 12. The arm 12 extends into trough 42 and then bends ninety degrees and forms pushing fingers as shown in FIG. 1. The gear motor 56 of the chain 74 is timed to cause one push arm 12 to travel the length of the trough 42 in approximately forty seconds. It takes a doughnut twenty seconds to be cooked on one side, and another twenty seconds to be cooked on the opposite side. Large drive gear 84 is driven by motor gear 82 powered by 120 VAC electric motor 80. The drive chain 74 includes notches 75 that are engaged by corresponding ribs located on a concentric rib 86 that is protruding from the large drive wheel 88. This engagement causes the drive chain 74 to be transported around guide wheel 90 and guide rollers 32, 34. As the push finger 12 nears the end of its journey in oil 28, it pushes the doughnut up the ramp 43 at the end of trough 42 and finally down ramp 11 and continuing down ramp 4 which has been folded out as indicated by dotted line 5. The dispensing assembly 50 is removably attached to the housing by telescoping cylindrical shapes 68, 70. Electrical contacts located within the walls of each cylinder 68, 70 allow electricity to be passed to the dispensing motor 56 from a power source located below in the main housing 6. Batter hopper 63 can also be removed for cleaning or filling and then replaced into an aperture in housing 6.

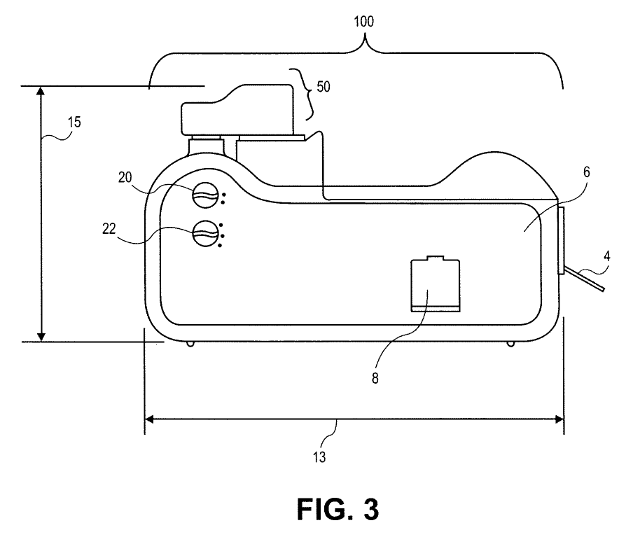

FIG. 3 shows a front view of the invention 100. The dimensions of the invention are approximately twenty two inches in length as shown by dimension arrow 13 and twelve inches high as shown by dimension arrow 15. This relatively small size makes the invention ideal for use in a home environment where counter space may be limited. Careful attention has been given to the design of all components of the invention to enable it to be as compact as possible.

FIG. 4 shows a rear perspective view of the invention 100. The rear panel 2 is designed to be removable and replaceable by the user. When it is removed, the entire chain drive including push fingers 12 and idler rollers 32, 34, 90 are removed as one assembly allowing for easy cleaning of the push fingers. The chain drive motor 80 and gear 82 remain within housing 6. In this view, power cord 40 can be seen. Plug 41 fits into a standard 120 VAC household socket. Dispenser assembly retaining socket 68 can be clearly seen, as can transparent lid 36.

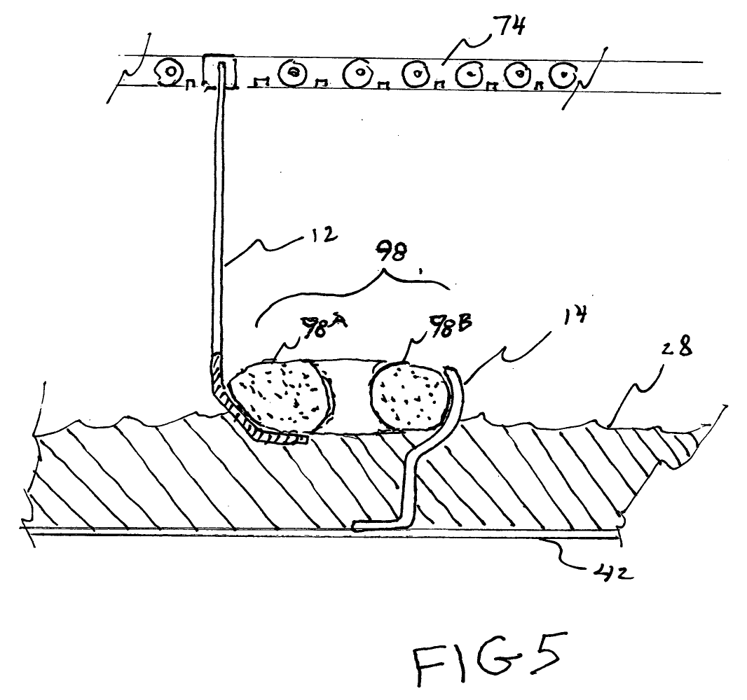

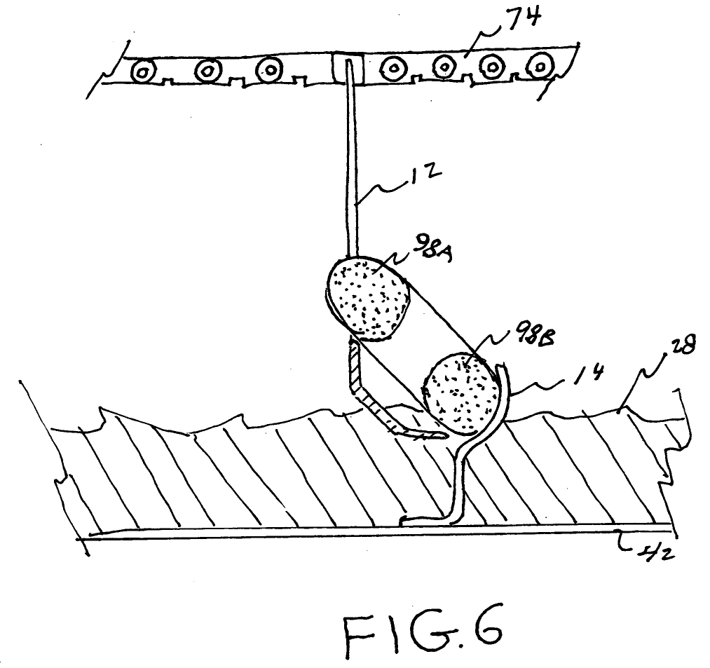

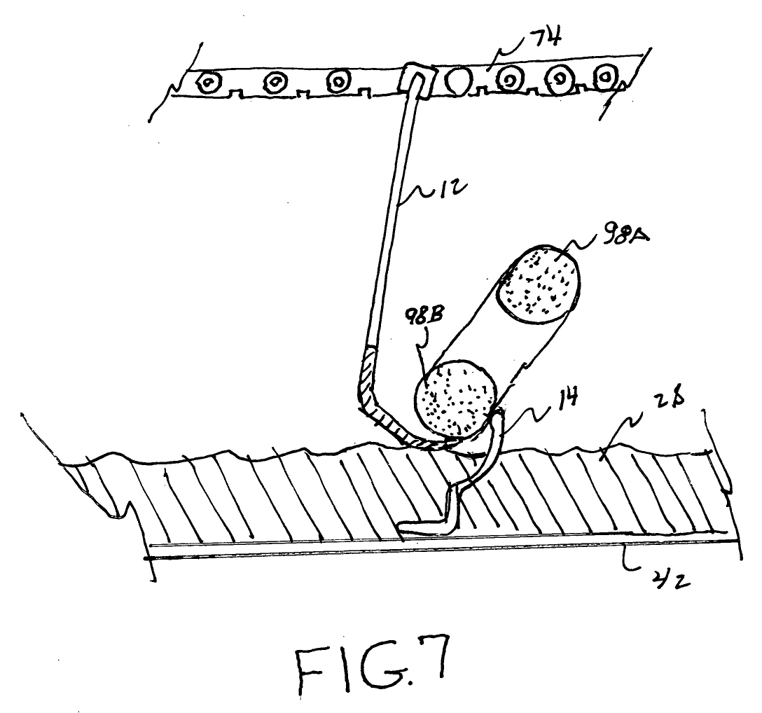

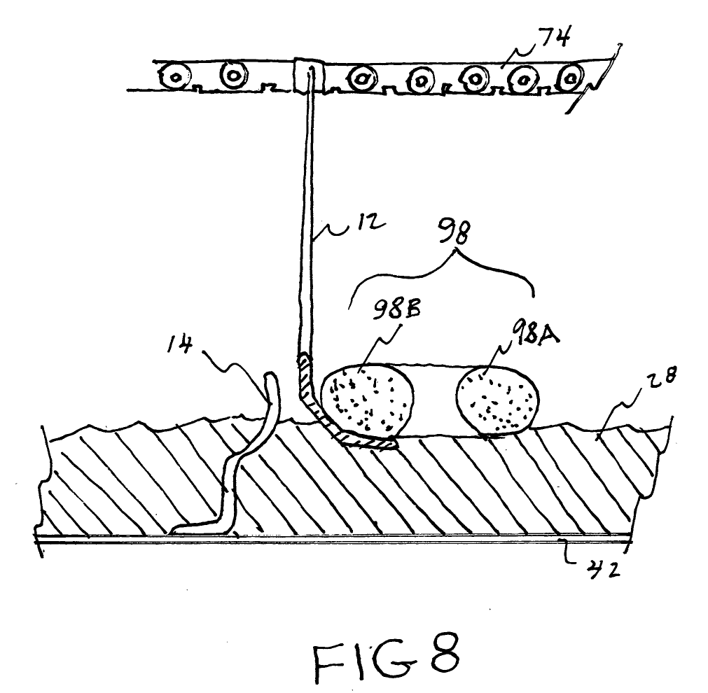

FIGS. 5, 6, 7, 8 show the flipping sequence of a doughnut 98 as push arm 12 causes the doughnut 98 to interact with flip arm 14. As the push arm 12 transports the doughnut 98, floating in oil 28, the doughnut 98 encounters flip arm'14 approximately half way along the length of its travel in trough 42 as shown in FIG. 5. Push arm 12 continues to urge doughnut 98 forward where the leading edge of the doughnut 98B encounters the flipping fingers 14. The interaction with flipping fingers 14 causes the doughnut to begin to rotate so that one side of the doughnut 98A is lifted out of oil 28. Continued pushing as shown in FIG. 7 causes the doughnut 98 to begin to flip. Pushing arm 12 and flipping arm 14 are made of thin stainless steel and are somewhat flexible which helps facilitate the flipping action. The push fingers 12 are interlaced with the push fingers 14 so that fingers 12 can travel past fingers 14 without interfering with each other. FIG. 8 shows the doughnut 98 in a flipped position as indicated by the fact that end 98A is now at the leading edge and 98B is at the trailing edge.

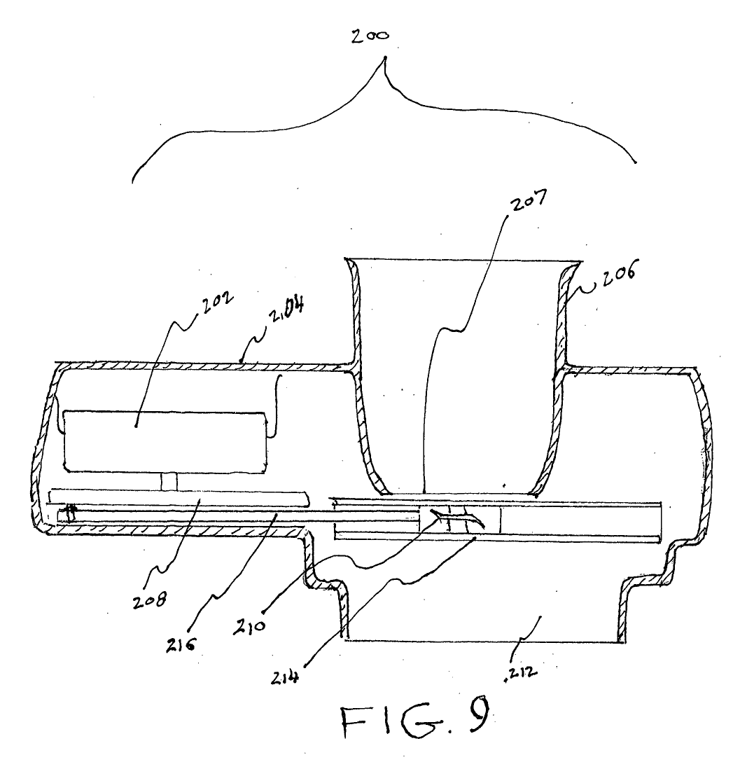

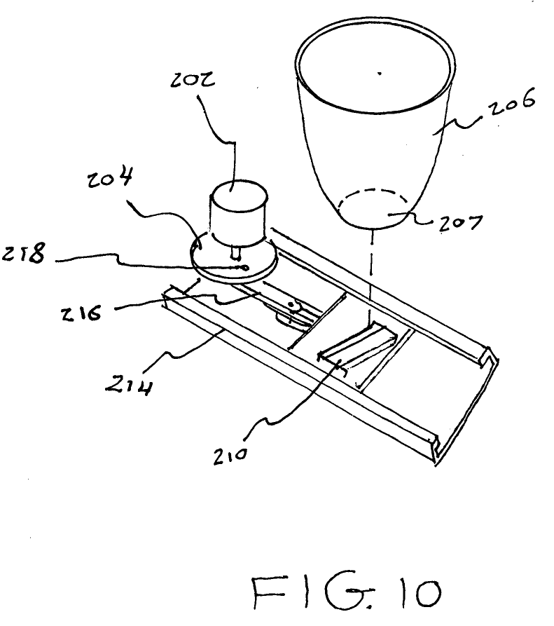

FIG. 9 shows an alternate dispensing assembly 200 that is designed to slice potato's and allow them to drop into the hot oil 28. By removing the doughnut dispensing assembly 50 and replacing it with potato chip making assembly 20, the present invention 100 doubles as a potato chip making machine. Potato's are placed in hopper 206. Drive motor 202, located within housing 204 turns a wheel 208 having a drive arm 216 pinned to it causing the drive arm 216 to move in a reciprocating fashion causing cutting blade 210 to move forward and backward thereby slicing the potato's that exit the bottom 207 of hopper 206 to be sliced and then to drop though aperture 212 and into the oil 28 held within trough 42. The push fingers 12 move the chips down the length of the trough until they are pushed out ramp 4 and into a waiting tray or dish supplied by the user. FIG. 10 is an exploded perspective view of the potato chip slicing assembly showing more clearly the elements of the assembly including hopper 206, drive motor 202, drive wheel 204, connecting pin 218, reciprocating drive arm 216 and knife assembly 210 which travels back and forth in track 214.

FIG. 11 shows a top view of the invention 100 and includes section line 102 which informs the section drawing shown in FIG. 2.

The above description and drawings show that the present invention provides an easy, economical and compact way to make doughnuts or potato chips. It is intended for household use and therefore has been designed for easy cleaning and for safe usage of adults having no special skill in doughnut making. Whereas commercial doughnut making machines cost, at a minimum, $3,500.00, the doughnut making machine of the present invention can be purchased for under $200.00.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. Doughnut making machine comprising:
a metal trough;
a heating element;
a doughnut pushing chain including an evenly spaced plurality of attached doughnut pushing fingers one one side tabs for switch activation on the opposite side;
a chain drive motor;
a doughnut batter hopper;
a motorized batter dispensing mechanism;
a temperature sensing switch;
a plurality of chain idler pulleys
a chain drive pulley;
a doughnut flipping finger
an enclosure housing;
a Transparent top cover;
a power cord;
a batter dispensing switch;
a chain drive power switch;
a heater switch;
said chain being driven by said chain drive pulley that is in turn driven by said chain drive motor;
said chain being wrapped around said idler pulleys;
said batter dispensing mechanism removably located in a receiving aperture on the top surface of said housing;
said dispensing mechanism activates when said chain tabs contact said batter dispensing switch;
said doughnut batter being dropped into said metal trough;
said trough having a heating element in intimate contact with its bottom most surface so that oil that resides in said trough can be heated causing said doughnut batter to fry;
said resulting doughnut shape propelled forward by said push fingers;
said flipping fingers located mid way along said trough and offering resistance to said doughnut causing it to flip over;
said trough including an angled end wall that causes said doughnut to be slid out of said oil and dropped over the end of said trough into a waiting tray;
said chain drive assembly accessible for cleaning by an easily removable and replaceable back housing panel;
said dispenser motor and said chain drive motor and said heating element powered by said power cord that is plugged into a 120 VAC outlet and said power switch activating said belt drive motor and said heating element;

2. Doughnut making machine as claimed in claim 1 wherein said chain is constructed of flexible food grade nylon and includes a plurality of identical links;
each link including drive teeth, and certain links having an aperture for accepting one said doughnut pushing arm and attached fingers, and one tab for activating said dough dispensing switch;
each end of each said chain link including a hinge member for attaching one said link to another by hinge pins until a continuous belt of chain is fabricated.

3. Doughnut making machine as claimed in claim 1 wherein an alternative dispensing assembly can be placed on top of said top housing;
said alternate dispensing assembly including a motorized slicing device;
said alternate dispenser capable of slicing potato's or other vegetables so that said slices drop into said trough and are fried in said oil and are propelled by said pushing fingers until said potato chips fall over said angled trough end into said waiting tray.
